(19) United States
(12) Patent Application Publication
(10) Pub. No.: US 2016/0014952 A1
(43) Pub. Date: Jan. 21, 2016

(54) SOWING HEART AND SINGLE-SEED DRILL

(71) Applicant: KVERNELAND AS, Kvernaland (NO)

(72) Inventor: Ferdinand Schumacher, Lippetal-Oestinghausen (DE)

(73) Assignee: KVERNELAND AS, Kvernaland (NO)

(21) Appl. No.: 14/755,189

(22) Filed: Jun. 30, 2015

(30) Foreign Application Priority Data
Jul. 17, 2014 (EP) 14177500.7

(51) Int. Cl. A01C 7/20; A01C 7/04

(52) U.S. Cl. CPC A01C 7/20; A01C 7/046

(57) ABSTRACT

A sowing heart for a single-seed drill, wherein the sowing heart includes a seed disc which can be rotated in one direction (R) of rotation, the seed disc having seed holes in a defined arrangement; a receiving region for receiving the seed into the seed holes and a delivery region for delivery of the seed; a cleaning apparatus located between the delivery region and the receiving region for cleaning of the seed holes during the operation of the sowing heart, wherein the cleaning apparatus is made as a rotating wheel with at least one projection which meshes with the seed holes. The invention is also directed to a single-seed drill with such a sowing heart.

### Field of the Invention

This invention relates to a sowing heart for a single-seed drill, having a seed disc with seed holes and a cleaning apparatus for cleaning of the seed holes, as well as a single-seed drill with this sowing heart.

### BACKGROUND OF THE INVENTION

Sowing hearts and single-seed drills are known from the prior art. Known sowing hearts for, in particular pneumatic, single-seed drills generally consist of two parts, specifically a rear part which houses the bearing system of the seed disc and a negative pressure region, and a front part into which the lower output of a seed tank discharges and which itself has a seed reservoir.

In order to prepare the seed disc for replenishment with seed, in particular for very small and/or fine seed, the seed holes in the seed disc are cleared with overpressure. For this purpose, on the back of the seed disc a nozzle is attached tightly adjacent to the seed disc such that compressed air can be blown through each seed hole in order to clear seed residues from the seed holes.

The nozzle is subject to wear since it is abraded by the rotating seed disc. Moreover, the nozzle clogs very quickly since it is adversely affected by dirt in the compressed air, due to abrasion, pickling or impurities on the seed disc. Another disadvantage is that the cleaning action of the nozzle is unsatisfactory, in particular after longer use.

### SUMMARY OF INVENTION

An object of this invention is therefore to provide a sowing heart and a single-seed drill with improved cleaning action.

This object is achieved with the sowing heart and the single-seed drill according to the independent claims. Advantageous developments of the invention are given in the dependent claims. Moreover, all combinations of at least two features disclosed in the specification, the claims and/or the figures fall within the scope of the invention.

The sowing heart according to an embodiment of the present invention has the following features:
a seed disc which can be rotated in one direction of rotation,
the seed disc has seed holes in a defined arrangement,
a receiving region for receiving the seed into the seed holes and a delivery region for delivery of the seed,
between the delivery region and the receiving region there is a cleaning apparatus for cleaning of the seed holes during the operation of the sowing heart.

The cleaning apparatus is made as a rotating wheel with at least one projection which meshes with the seed holes. Advantageously especially thorough cleaning of the seed holes can be achieved by the at least one meshing projection. In particular, the at least one projection can expel the seed residue from the seed holes and/or strip the seed residue from the seed holes, for example pickling with which the seed is impregnated, the pickling detaching from the seed and in this way it can clog the holes.

Seed within the scope of this invention comprises for example fertilizer, seed grains, pelleted or unpelleted, etc.

The basic structure and the fundamental manner of operation of the sowing heart and of the single-seed drill are known from document EP 2 341 765, whose full disclosure is expressly incorporated herein by reference.

According to one preferred embodiment it is provided that the wheel can be driven by at least temporary contact with the seed disc. In particular, it can be provided that the seed disc drives a wheel by the at least one projection being entrained by the seed holes. The wheel continues to turn or turns at the same time by the rotation of the seed disc. In this way the rotation of the seed disc can be used to turn the wheel so that advantageously an independent drive of the wheel is not necessary and energy can be saved. Alternatively, it can be provided that the wheel is turned by its own drive, for example hydraulically and/or electrically.

The seed holes can be arranged in particular on a circular path or on several circular paths in the seed disc, the wheel being located on a quadrant region of the circular path or one of the circular paths. According to one preferred embodiment the sowing heart can have several wheels with at least one projection each. In particular, if the seed holes are located on several circular paths in the seed disc, one such wheel at a time can be assigned to each of several circular paths. This has the advantage that even for a seed disc with several circular paths of seed holes, efficient cleaning can take place by several wheels.

The at least one projection meshes with the seed holes, in particular the at least one projection being located within the seed holes during meshing, at least partially, in particular with its tip or its forward end. It is preferred that the at least one projection at least partially punches through the seed holes. In other words: the at least one projection completely traverses the seed holes with its tip or its forward end. Advantageously especially good removal of seed residues from the seed holes can take place by this punching-through.

The at least one projection can fundamentally have any cross section, therefore in particular a round, circular, oval, triangular, quadrangular, square, rectangular, pentagonal, hexagonal, polygonal, etc. cross section. The at least one projection can have over its length a constant cross section, preferably the at least one projection however has a cross section which is variable over its length, in particular which decreases over its length.

It is preferably provided that the at least one projection tapers to the outside, i.e. away from the axis of rotation of the wheel, in particular is made pointed or spiked. In this way an especially efficient expulsion of seed residues can be advantageously achieved. Moreover, it is preferably provided that the, in particular maximum, cross section of at least one projection is smaller than the, in particular minimum, cross section of the seed holes. In this way it can be advantageously achieved that the at least one projection—in particular with its entire length—meshes with the seed holes especially extensively, in particular at least one third, preferably at least half, of the seed hole depth. It is in particular preferred that the at least one projection has a circular cross section. It is quite preferably preferred that the at least one projection is made in the shape of a circular cone, in particular the tip of the circular cone pointing away from the axis of rotation of the wheel. In this way especially efficient cleaning can be achieved, in particular for the case in which the seed holes are made with a circular cross section.

The at least one projection can be shaped, in particular integrally, from the material of the wheel, and in particular can be an integral component of the wheel. Alternatively the at least one projection can be made as a separate component and can be attached in particular to the surface of the wheel, in particular by cementing, welding, soldering, or similar methods.

According to one especially preferred embodiment it is provided that the wheel, in particular with its outer circumference, rolls along the in particular front-end surface of the seed disk. This can result in especially good transfer of force between the seed disc and wheel. In particular it can be provided that the at least one projection is located on the outer circumference of the wheel which is made in particular in the shape of a round disc. Furthermore it is preferably provided that the axis of rotation of the wheel is perpendicular to the axis of rotation of the seed disc. In this way an especially compact construction of the sowing heart is advantageously possible.

Furthermore, it is preferably provided that the seed disc and the wheel turn with the same angular velocity. This enables especially good matching of the rotation of the wheel to the rotation of the seed disc.

Furthermore, it is preferred that the wheel be located on the side of the seed disc facing away from the suction chamber or a negative pressure region of the sowing heart. Advantageously this can result in that the projections force the seed residue out of the seed hole and the negative pressure in the suction chamber sucks the seed residue out of the seed hole so that improved cleaning can be advantageously achieved.

In another preferred embodiment the sowing heart has a pressing apparatus which forces the wheel onto the surface, in particular onto the face surface of the seed disc. The pressing apparatus can in particular have at least one compression spring which applies a compressive force to the wheel in the direction of the surface of the seed disc. Advantageously this can yield first of all especially efficient cleaning and secondly improved transfer of force between the seed disc and the wheel.

It is furthermore preferably provided that the wheel has a plurality of projections which are spaced in particular uniformly apart from one another, in particular the distance of adjacent projections corresponding to the distance of adjacent seed holes. It can be provided in particular that in operation the projections mesh in succession with succeeding seed holes. Moreover, it can be preferably provided that the projections are arranged in the peripheral direction over the entire outer circumference of the wheel, in particular are distributed equidistantly.

According to another preferred embodiment it is provided that in the operation of the plurality of projections at least one projection always meshes with one seed hole. In this way especially efficient cleaning of the seed holes and especially good transfer of force can be advantageously achieved. Furthermore, it can be preferably provided that in operation at least temporarily at least two projections each mesh with one seed hole. In this way first of all the cleaning can be still further improved and secondly the transfer of force can be made still more efficient.

The wheel has preferably at least five projections, especially preferably at least ten, quite especially preferably at least fifteen projections.

The projections can be made identical in particular with respect to their length, shape, their cross section, material, etc. Alternatively, the projections can be made differently.

Another subject matter of this invention relates to a single-seed drill, having a sowing heart according to one of the above described embodiments. Reference is made to the aforementioned on the advantages and exemplary developments.

Other advantages, features and details of the invention will become apparent from the following description of preferred embodiments and using the drawings.

### BRIEF DESCRIPTION OF DRAWINGS

The figures are schematic.

FIG. 1a shows a sowing heart according to one exemplary embodiment of this invention,

FIG. 1b shows the sowing heart from FIG. 1a in a perspective view,

FIG. 2 shows an enlarged view of the sowing heart from FIG. 1b,

FIG. 3a shows a sectional view of the sowing heart from FIG. 1a,

FIG. 3b shows an enlarged view of the sowing heart from FIG. 3a, and

FIG. 4 shows a detailed view of the sowing heart from FIG. 1.

### DETAILED DESCRIPTION OF THE PREFERRED EMBODIMENTS

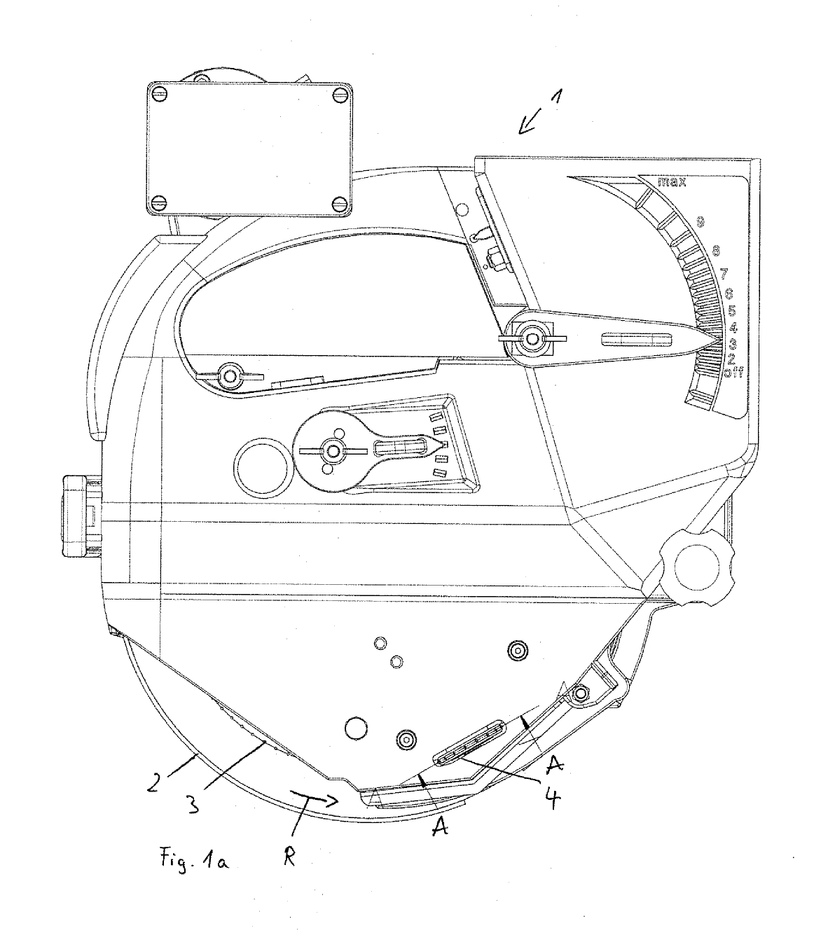

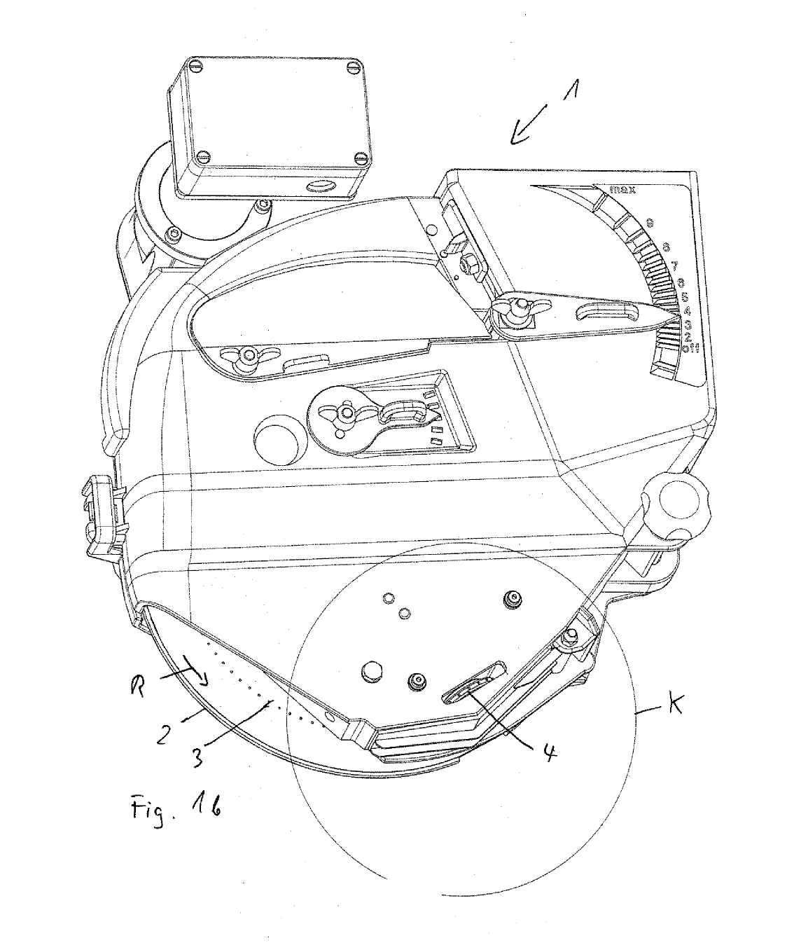

FIG. 1a schematically shows a sowing heart 1 according to one exemplary embodiment of this invention in a side view. FIG. 1b shows the sowing heart 1 in a perspective view.

The basic structure and the fundamental manner of operation of the sowing heart 1 are known from document EP 2 341 765 whose disclosure is fully incorporated herein by reference.

The sowing heart 1 has a working space which is encompassed by its two parts or halves and which is divided by a seed disc 2 into a pressure chamber and a seed chamber. The pressure chamber is divided into a negative pressure region and a normal pressure region by a preferably conventional gasket. In the negative pressure region there is a pressure difference on the seed holes 3 which are used to accept and deliver the seed; this pressure difference is triggered in the normal pressure region, as a result of which in the transition of the seed holes 3 from the negative pressure region into the normal pressure region the seed is ejected by rotational movement of the seed disc 2 in one direction of rotation (running direction) R of the seed disc 2.

The negative pressure region is subjected to negative pressure by a pump which is not shown or a negative pressure fan via a connection.

The seed holes 3 are arranged on a circular path of the seed disc 2 at defined distances, and there can also be several circular paths with seed holes 3.

The sowing heart 1 has a cleaning apparatus 4 which is made as a rotating wheel 4 with a plurality of projections 5.

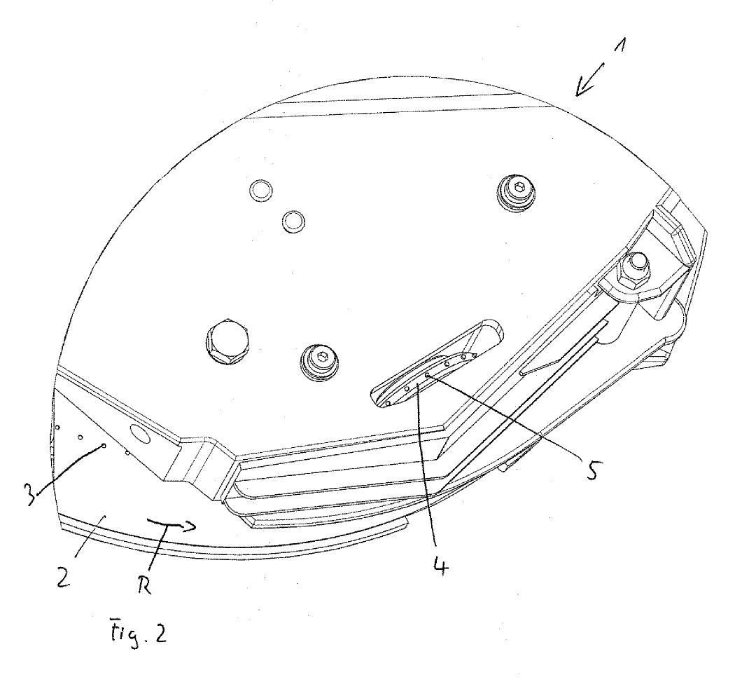

FIG. 2 shows an enlarged view of one part of the sowing heart 1 from FIG. 1b. FIG. 2 shows that region of the sowing heart 1 which is identified by the circle K in FIG. 1b. The wheel 4 has a plurality of projections 5. The projections 5 are located on the outer circumference of the wheel 4.

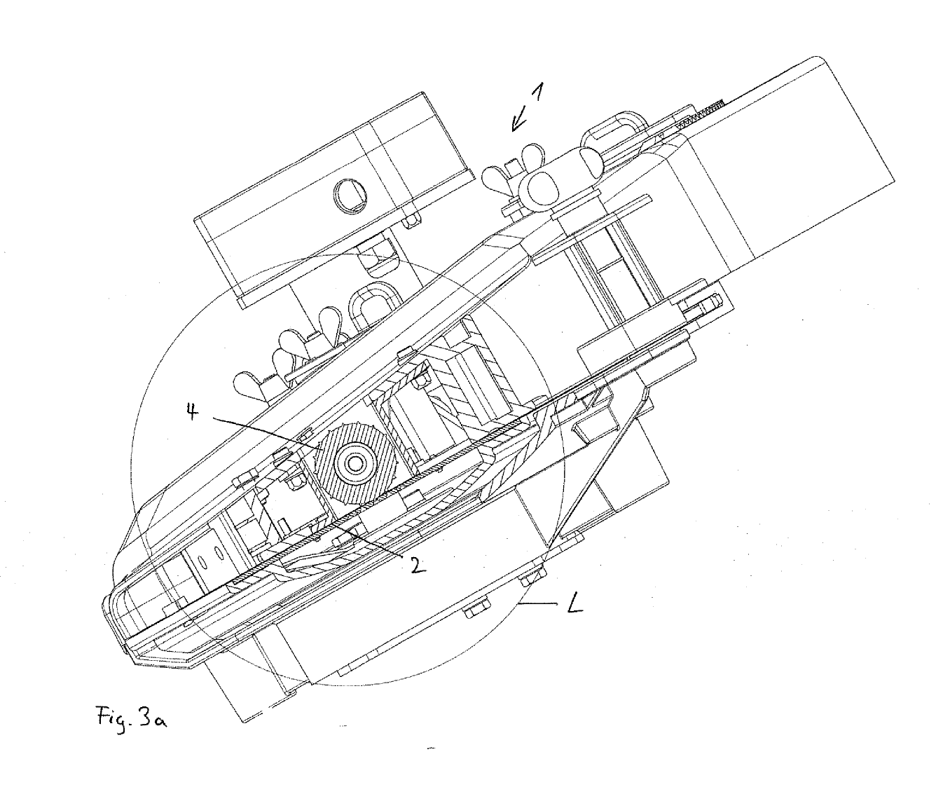

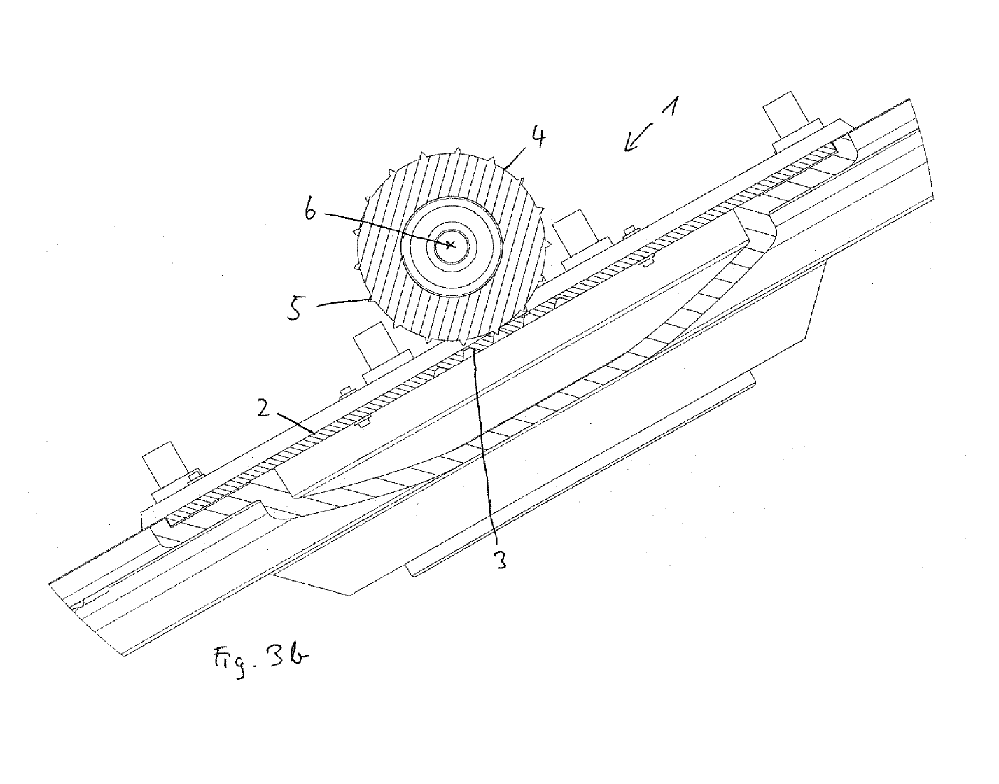

FIG. 3a schematically shows a sectional view of the sowing heart 1 in the region of the wheel 4. The section runs along the line A-A which is shown in FIG. 1a. FIG. 3b schematically shows an enlarged view of the sowing heart from FIG. 3a. FIG. 3b shows that region of the sowing heart 1 which is identified by the circle L in FIG. 3a. The wheel 4 turns around an axis 6 of rotation which is located perpendicular to the axis of rotation of the sowing heart 2. The projections 5 mesh with the seed holes 3. The projections 5 are made pointed in order to achieve an especially good cleaning action. The wheel 4 is driven by the rotary motion of the seed disc 2, by the contact of the projections 5 with the edges of the seed holes 3 the force being transferred from the seed disc 2 to the wheel 4. FIGS. 3a and 3b show a state in which only one single projection 5 meshes with one seed hole 3.

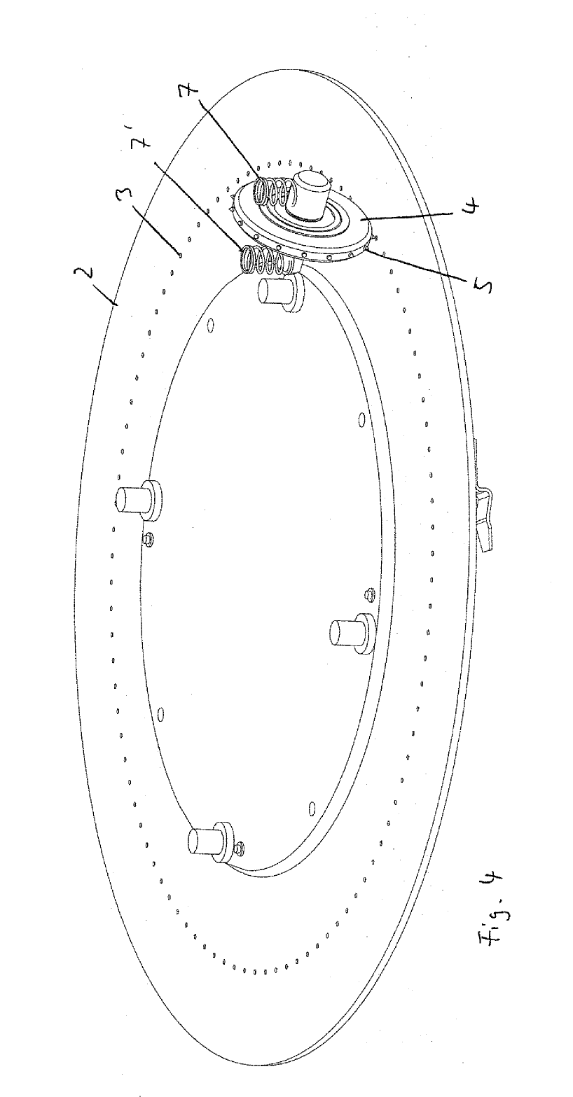

FIG. 4 schematically shows in a detailed view only parts of the sowing heart 1, for better illustration. FIG. 4 shows the seed disc 2 which is made in the shape of a round disc with the seed holes 3 and the wheel 4. The seed holes 3 run on a circular path in the seed disc 2. The wheel 4 with the projections 5 is located on a partial region of this circular path. The wheel 4 is located vertically on the surface of the seed disc 2. In operation, the projections 5 which are located on the outer circumference of the wheel 4 mesh in succession with succeeding seed holes 3. The projections 5 are spaced at the same distance from one another and run over the entire outer circumference of the wheel 4, i.e. the projections 5 are arranged distributed over the entire outer circumference of the wheel 4. The sowing heart 1 furthermore has two springs 7, 7′ which press the wheel 4 onto the surface of the seed disc 2. In this way, first of all improved cleaning action and secondly improved transfer of force from the seed disc 2 to the wheel 4 is achieved.

The above described exemplary embodiments are used solely for illustration of the invention and are not intended to restrict the subject matter of the invention at all.

### DESCRIPTION OF THE REFERENCE NUMERALS

1 sowing heart

2 seed disc

3 seed holes

4 wheel

5 projections

6 axis of rotation

7, 7′ spring

R direction of rotation

K, L circle

Having described the invention, the following is claimed:

1. A sowing heart for a single-seed drill, the sowing heart comprising:
a seed disc rotatable in one direction (R) of rotation, the seed disc including seed holes in a defined arrangement,
a receiving region for receiving seed into the seed holes and a delivery region for delivery of the seed, and
a cleaning apparatus located between the delivery region and the receiving region, the cleaning apparatus cleaning the seed holes during operation of the sowing heart, wherein the cleaning apparatus is formed as a rotating wheel having at least one projection which meshes with the seed holes.

2. The sowing heart as claimed in claim 1, wherein the wheel can be driven by at least temporary contact with the seed disc.

3. The sowing heart as claimed in claim 1, wherein the at least one projection at least partially punches through the seed holes.

4. The sowing heart as claimed in claim 1, wherein the at least one projection tapers to the outside, the at least one projection having the shape of a circular cone.

5. The sowing heart as claimed in claim 1, wherein a maximum, cross section of at least one projection is smaller than a minimum, cross section of the seed holes.

6. The sowing heart as claimed in claim 1, wherein the at least one projection has a circular cross section.

7. The sowing heart as claimed in claim 1, wherein the at least one projection is located on the outer circumference of the wheel.

8. The sowing heart as claimed in claim 1, wherein an axis of rotation of the wheel is located perpendicular to an axis of rotation of the seed disc.

9. The sowing heart as claimed in claim 1, wherein the wheel is located on the side of the seed disc facing away from a suction chamber of the sowing heart.

10. The sowing heart as claimed in claim 1, wherein the sowing heart further comprises a pressing apparatus which forces the wheel onto the surface of the seed disc.

11. The sowing heart as claimed in claim 1, wherein the wheel rolls along the front-end, surface of the seed disc with its outer circumference.

12. The sowing heart as claimed in claim 1, wherein the wheel has a plurality of projections which are spaced apart from one another, wherein the distance of adjacent projections corresponds to the distance of adjacent seed holes.

13. The sowing heart as claimed in claim 12, wherein at least one projection of the plurality of projections in operation always meshes with one seed hole.

14. The sowing heart as claimed in claim 12, wherein in operation at least temporarily at least two projections mesh with each one seed hole at a time.

15. A single-seed drill comprising:
a sowing heart including:
a seed disc rotatable in one direction (R) of rotation, the seed disc including seed holes in a defined arrangement,
a receiving region for receiving seed into the seed holes and a delivery region for delivery of the seed, and
a cleaning apparatus located between the delivery region and the receiving region, the cleaning apparatus cleaning the seed holes during operation of the sowing heart, wherein the cleaning apparatus is formed as a rotating wheel having at least one projection which meshes with the seed holes.

16. The sowing heart as claimed in claim 4, wherein said at least one projection is pointed.

17. The sowing heart as claimed in claim 7, wherein said wheel is shaped as a round disc.

18. The sowing heart as claimed in claim 10, wherein said pressing apparatus is spring-loaded.

19. The sowing heart as claimed in claim 12, wherein said plurality of projections are uniformly spaced apart from one another.
